(19) United States
(12) Patent Application Publication
(10) Pub. No.: US 2014/0055062 A1
(43) Pub. Date: Feb. 27, 2014

(54) SWITCHING APPARATUS FOR TWO-PHASE SRM AND CONTROL METHOD THEREOF

(71) Applicant: SAMSUNG ELECTRO-MECHANICS CO., LTD., Suwon (KR)

(72) Inventors: Hyung Joon Kim, Suwon (KR); Joung Ho Son, Suwon (KR); Han Kyung Bae, Suwon (KR)

(73) Assignee: SAMSUNG ELECTRO-MECHANICS CO., LTD., Suwon (KR)

(21) Appl. No.: 13/783,171

(22) Filed: Mar. 1, 2013

(30) Foreign Application Priority Data
Aug. 22, 2012 (KR) 10-2012-0091683

(51) Int. Cl. H02P 25/08

(52) U.S. Cl. CPC H02P 25/082
USPC 318/254.1

(57) ABSTRACT

Disclosed herein are a switching apparatus for a two-phase SRM and a control method thereof. The switching apparatus for a two-phase SRM includes: a rectifier rectifying commercial power; and a zero-voltage switching converter including a pair of upper and lower switches that is vertically connected to each of two phase windings in series and a pair of diodes that is cross-connected across the two phase windings to be operated in operation modes 1 to 3 for each phase winding and provide commercial power supplied from the rectifier to the two-phase SRM so as to operate the two-phase SRM.

### CROSS REFERENCE TO RELATED APPLICATION

This application claims the benefit of Korean Patent Application No. 10-2012-0091683, filed on Aug. 22, 2012, entitled “Switching Apparatus For Two-Phase SRM And Control Method Thereof”, which is hereby incorporated by reference in its entirety into this application.

### BACKGROUND OF THE INVENTION

1. Technical Field

The present invention relates to a switching apparatus for a two-phase SRM and a control method thereof.

2. Description of the Related Art

A switched reluctance motor (hereinafter, referred to as SRM) is a motor with which a switching control apparatus is coupled and includes a stator and a rotor having a salient pole type structure.

In particular, only a stator portion is wound with a winding and a rotor portion does not have any type of windings or permanent magnets and therefore, a structure of a motor is simplified.

Due to the characteristics of the structure, it is significantly advantageous in manufacturing and production. The switched reluctance motor has excellent characteristics such as good starting property and torque like a DC motor, little maintenance, torque per one unit volume, efficiency, rating of a converter, or the like. Therefore, the switched reluctance motor has been widely applied to various applications.

There are various types of switched reluctance motors such as a single phase, a two-phase, a three phase, and the like. In particular, the two-phase SRM has been significantly interested in applications, such as a fan, a blower, a compressor, and the like, by having a simpler driving circuit than that of the three-phase SRM.

Further, the switching apparatus for the two-phase SRM has used various methods for controlling current of a stator winding in one direction. There is the switching apparatus using an asymmetric bridge converter for driving the existing AC motor using the used types.

The asymmetric bridge converter has two switches and diodes and has a three-stage operation mode.

Herein, operation mode 1 is a mode that turns-on two switches to apply DC power supply voltage to a winding and increase current, operation mode 2 is a mode that turns-off one switch when current flows in a winding to circulate current and slowly reduce current, and operation mode 3 is a mode that simultaneously turns-off two switches to rapidly reduce current.

The asymmetric bridge converter operated as described above have the most excellent diversity of control among converters for driving an SRM and independently controls current of each phase to impose current superimposing of two-phases. Further, the asymmetric bridge converter is suitable for high voltage and large capacity and has relatively low rated voltage of a switch.

However, when the switching apparatus is driven in a high-speed rotation area of 100,000 RPM or more, switching loss of an inverter circuit or a converter circuit configuring the switching apparatus is increased and thus, efficiency may be reduced.

### PRIOR ART DOCUMENT

### Patent Document

(Patent Document 1) Korean Patent Laid-Open Publication No. 2007-0104142

### SUMMARY OF THE INVENTION

The present invention has been made in an effort to provide a switching apparatus of a two-phase SRM using a zero-voltage turn-on switching technique and a control method thereof.

According to a preferred embodiment of the present invention, there is provided a switching apparatus for a two-phase SRM, including: a rectifier rectifying commercial power; and a zero-voltage switching converter including a pair of upper and lower switches that is vertically connected to each of two phase windings in series and a pair of diodes that is cross-connected across the two phase windings to be operated in operation modes 1 to 3 for each phase winding and provide commercial power supplied from the rectifier to the two-phase SRM so as to operate the two-phase SRM.

The switching apparatus for a two-phase SRM may further include: a microprocessor sensing a position and a speed of the two-phase SRM to control the zero-voltage switching converter so as to operate the two-phase SRM.

The pair of upper and lower switches may include: a first upper switch connected to an upper portion of any one of the two phase windings in series; a first lower switch connected to a lower portion of any one of the two phase windings in series; a second upper switch connected to an upper portion of the other of the two phase windings in series; and a second lower switch connected to a lower portion of the other of the two phase windings in series, and the pair of diodes may include: a first diode having an anode connected to a contact between any one of the two phase windings and the first lower switch and a cathode connected to a contact between the other of the two phase windings and the second upper switch; and a second diode having an anode connected to a contact between the other of the two phase windings and a cathode connected to a contact between the other of the two phase windings and the upper switch.

The zero-voltage switching converter may control the first lower switch and the second upper switch based on an encoder waveform to control an advance angle.

The zero-voltage switching converter may control the first upper switch and a second lower switch to control a conducting angle.

The first upper switch and the first lower switch may be turned-on so as to be operated in the operation mode 1 for any one of the two phase windings of the two-phase SRM; and the second upper switch and the second lower switch may be turned-on so as to be operated in the operation mode 1 for the other of the two phase windings of the two-phase SRM.

The first upper switch may be turned-off and the first lower switch may be turned-on and then, the second lower switch may be turned-on so as to be operated in the operation mode 2 for any one of the two phase windings of the two-phase SRM; and the second upper switch may be turned-off and the second lower switch may be turned-on and then, the first lower switch may be turned-on so as to be operated in the operation mode 2 for any one of the two phase windings of the two-phase SRM.

An internal diode of the second upper switch may provide a circulating path of current in the state in which the second lower switch is turned-on so as to be operated in the operation mode 3 for any one of the two phase windings of the two-phase SRM, and an internal diode of the first upper switch may provide a circulating path of current in the state in which the first lower switch is turned-on so as to be operated in the operation mode 3 for any one of the two phase windings of the two-phase SRM.

The microprocessor may control the zero-voltage switching converter so as to be sequentially changed from the operation mode 1 to the operation mode 2 and the operation mode 3 for any one of the two phase windings and sequentially changed from the operation mode 1 to the operation mode 2 and the operation mode 3 for the other of the two phase windings.

When the microprocessor controls the zero-voltage switching converter so as to be changed from the operation mode 3 for any one of the two phase windings to the operation mode 1 for the other of the two phase windings, the operation mode 3 for any one of the two phase windings and the operation mode 1 for the other of the two phase windings may overlap each other for a predetermined time.

According to another preferred embodiment of the present invention, there is provided a switching control method for a two-phase SRM, including: (A) controlling, by a microprocessor, a zero-voltage switching converter including a pair of upper and lower switches that is vertically connected to each of two phase windings in series and a pair of diodes that is cross-connected across the two phase windings to be operated in operation modes 1 to 3 for each of the two phase windings to excite any one of the two phase windings and then, removing residual current; and (B) controlling, by the microprocessor, the zero-voltage switching converter to excite the other of the two phase windings and then, removing residual current.

The pair of upper and lower switches may include: a first upper switch connected to an upper portion of any one of the two phase windings in series; a first lower switch connected to a lower portion of any one of the two phase windings in series; a second upper switch connected to an upper portion of the other of the two phase windings in series; and a second lower switch connected to a lower portion of the other of the two phase windings in series, and the pair of diodes may include: a first diode having an anode connected to a contact between any one of the two phase windings and the first lower switch and a cathode connected to a contact between the other of the two phase windings and the second upper switch; and a second diode having an anode connected to a contact between the other of the two phase windings and a cathode connected to a contact between the other of the two phase windings and the upper switch.

In the step (A), the zero-voltage switching converter may be controlled so as to be sequentially changed from the operation mode 1 to the operation mode 2 and the operation mode 3 for any one of the two phase windings, and in the step (B), the zero-voltage switching converter may be controlled so as to be sequentially changed from the operation mode 1 to the operation mode 2 and the operation mode 3 for the other of the two phase windings.

When the microprocessor controls the zero-voltage switching converter so as to be changed from the operation mode 3 for any one of the two phase windings to the operation mode 1 for the other of the two phase windings, the operation mode 3 for any one of the two phase windings and the operation mode 1 for the other of the two phase windings may overlap each other for a predetermined time.

In the step (A), the first upper switch and the first lower switch may be turned-on so as to be operated in the operation mode 1 for any one of the two phase windings of the two-phase SRM; and in the step (B), the second upper switch and the second lower switch may be turned-on so as to be operated in the operation mode 1 for the other of the two phase windings of the two-phase SRM.

In the step (A), the first upper switch may be turned-off and the first lower switch may be turned-on and then, the second lower switch may be turned-on so as to be operated in the operation mode 2 for any one of the two phase windings of the two-phase SRM; and in the step (B), the second upper switch may be turned-off and the second lower switch may be turned-on and then, the first lower switch may be turned-on so as to be operated in the operation mode 2 for any one of the two phase windings of the two-phase SRM.

In the step (A), an internal diode of the second upper switch may provide a circulating path of current in the state in which the second lower switch is turned-on so as to be operated in the operation mode 3 for any one of the two phase windings of the two-phase SRM, and in the step (B), an internal diode of the first upper switch may provide a circulating path of current in the state in which the first lower switch is turned-on so as to be operated in the operation mode 3 for any one of the two phase windings of the two-phase SRM.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a configuration diagram of a switching apparatus for a two-phase switched reluctance motor according to a first preferred embodiment of the present invention;

FIG. 2 is a detailed configuration diagram of a zero-voltage switching converter of FIG. 1;

FIG. 3 is a waveform diagram showing an operation period of the corresponding switching of the zero-voltage switching converter of FIG. 2;

FIGS. 4A to 4F are exemplified diagrams for describing a current loop in an operation mode;

FIG. 5 is current and voltage waveform diagrams of corresponding elements of the zero-voltage switching converter of FIG. 2;

FIG. 6 is a flow chart of a switching control method for the two-phase switched reluctance motor according to the first preferred embodiment of the present invention;

FIG. 7 is a detailed process diagram of S200 of FIG. 6; and

FIG. 8 is a detailed process diagram of S400 of FIG. 6.

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, “one side”, “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention will be described in detail with reference to the attached drawings.

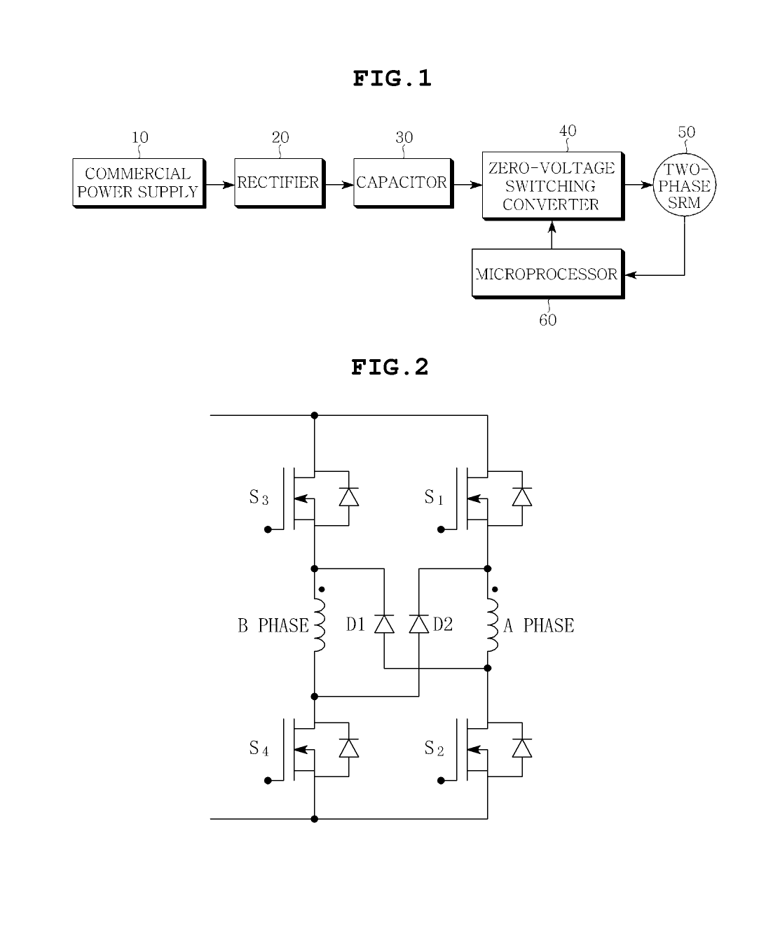

FIG. 1 is a configuration diagram of a switching apparatus for a two-phase switched reluctance motor according to a first preferred embodiment of the present invention.

Referring to FIG. 1, a switching control apparatus for a two-phase switch reluctance motor according to a first preferred embodiment of the present invention is configured to include a rectifier 20 that rectifies commercial power 10 and supplies DC power, a capacitor 30 that is connected to the rectifier 20, a zero-point switching converter 40 that is connected to the capacitor 30, and a microprocessor 60 that senses a position and a speed of a two-phase SRM 50 to control the zero-point switching converter 40.

The rectifier 20 rectifies the input commercial power 10 and supplies the rectified power to the capacitor 30. Further, the capacitor 30 improves a power factor of the rectified DC voltage and absorbs noise thereof so as to be supplied to the zero-voltage switching converter 40.

The zero-voltage switching converter 40 includes a pair of upper and lower switches that are vertically connected to each of two phase windings of the two-phase SRM 50 in series and a pair of diodes that is cross-connected across the two phase windings to be operated in operation modes 1 to 3 according to the control of the microprocessor 60, thereby driving the two-phase SRM 50.

Meanwhile, the microprocessor 60 senses the position and speed of the two-phase SRM 50 to control the pair of upper and lower switches of the switching converter 40, such that the switches are operated in the operation modes 1 to 3, thereby driving the two-phase SRM 50.

Herein, the operation mode 1 applies positive DC voltage to the corresponding phase winding of the two-phase SRM 50 to increase current flowing in a winding, the operation mode 2 circulates current to the winding when current flows in the winding to slowly reduce current, and the operation mode 3 applies negative DC voltage to the corresponding phase winding to rapidly reduce current.

The switching apparatus for the two-phase switched reluctance motor configured as above is operated as follows.

First, the microprocessor 60 controls the zero-voltage switching converter 40 to be operated in the operation modes 1 to 3 to excite any one of the two phase windings of the two-phase SRM 50 and then, end the exciting state.

Continuously, the microprocessor 60 controls the zero-voltage switching converter 40 to be operated in the operation modes 1 to 3 to excite the other of the two phase windings of the two-phase SRM 50 and then, end the exciting state.

Next, the microprocessor 60 repeatedly performs the operation to operate the two-phase SRM 50.

In this case, the microprocessor 60 controls the zero-point voltage switching converter 40 to be operated in the operation modes 1 to 3, but can control the zero-point voltage switching converter 40 in various types.

FIG. 2 is a detailed configuration diagram of a zero-voltage switching converter of FIG. 1.

Referring to FIG. 2, the zero-point voltage switching converter of FIG. 1 includes a first upper switch S1 that is connected to an upper portion of an A phase winding in series, a first lower switch S2 that is connected to a lower portion of the A phase winding in series, a second upper switch S3 that is connected to an upper portion of a B phase winding in series, and a second lower switch S4 that is connected to a lower portion of the B phase winding in series.

In addition, the zero-point voltage switching converter 40 includes a first diode D1 having an anode connected to a contact between the A phase winding and the first lower switch S2 and a cathode connected to a contact between the B phase winding and the second upper switch S3 and a second diode D2 having an anode connected to a contact between the B phase winding and the second lower switch S4 and a cathode connected to a contact between the A phase winding and the first upper switch S1.

In the zero-voltage switching converter 40, the first upper switch S1 and the second lower switch S4 have a phase difference with respect to each other and are turned-on at each half period.

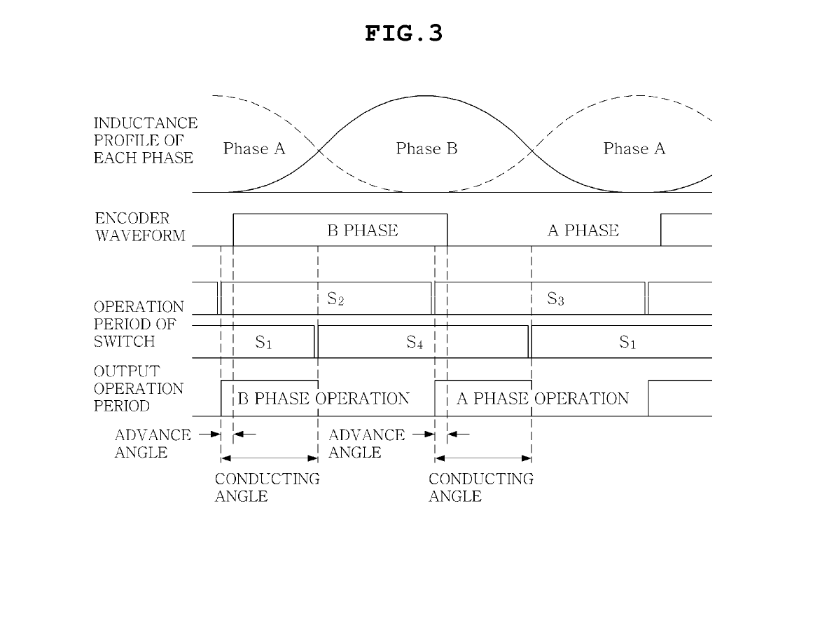

Further, as shown in FIG. 3, the first lower switch S2 and the second upper switch S3 have a phase difference with respect to each other and are turned-on at each half period.

The zero-voltage switching converter 40 may control an advance angle by controlling the first lower switch S2 and the second upper switch S3 and control a conducting angle by the first upper switch S1 and the second lower switch S4, based on an encoder waveform as shown in FIG. 3.

An operation of the zero-voltage switching converter 40 will now be described below.

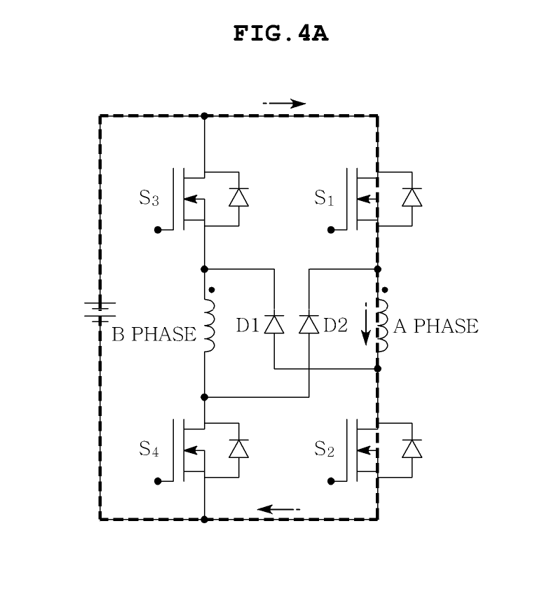

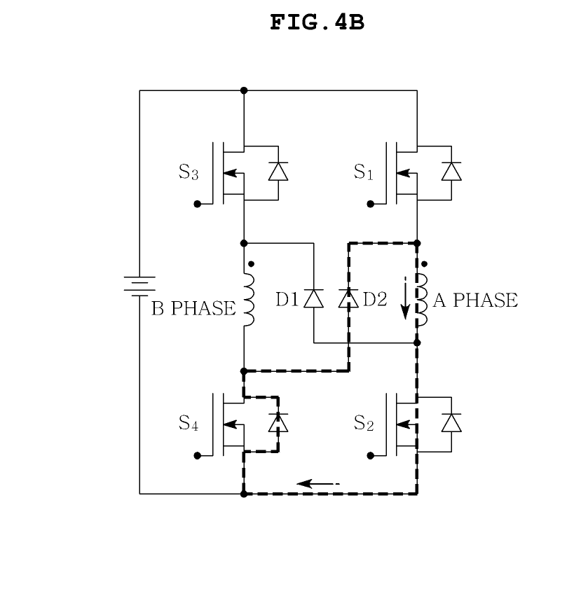

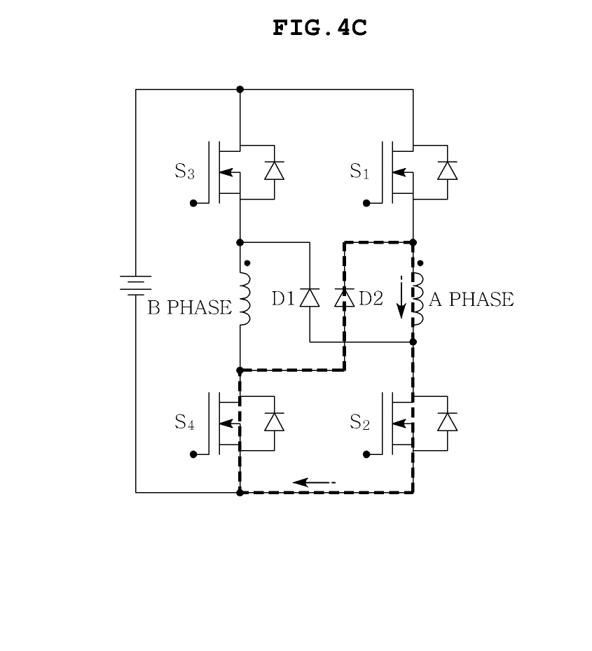

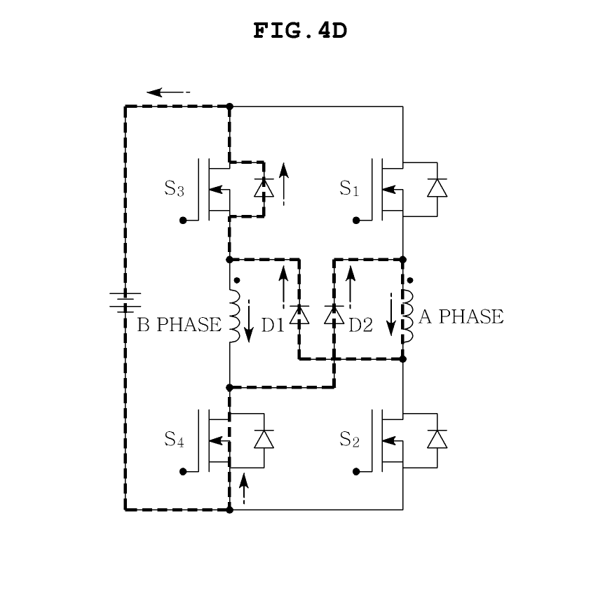

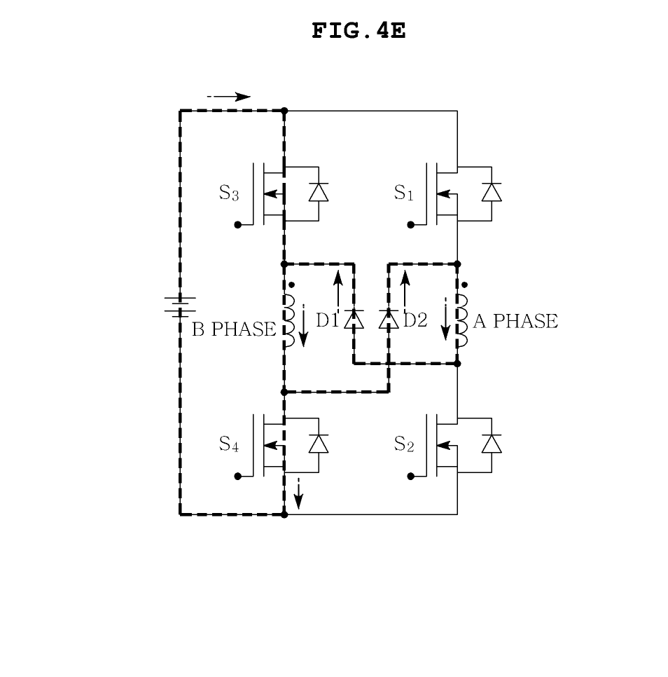

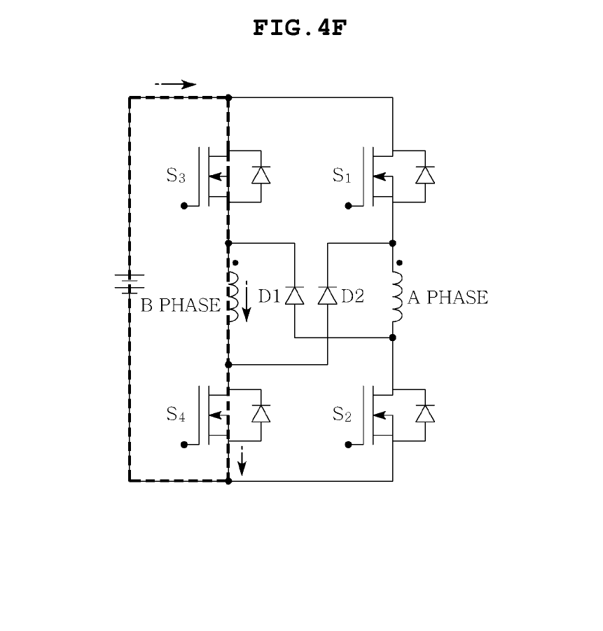

First, the first upper switch S1 and the first lower switch S2 are turned-on. As shown in FIG. 4A, a current loop configured of the first upper switch S1, the A phase winding, and the first lower switch S2 is formed (the A phase operation mode 1).

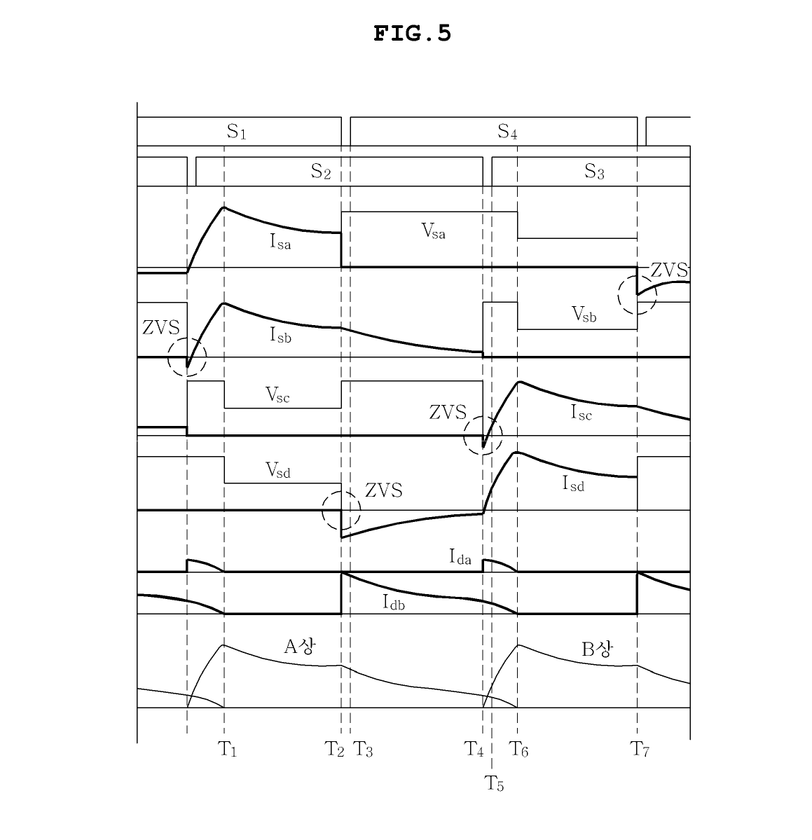

As such, when a predetermined time lapses after the first upper switch S1 and the first lower switch S2 are turned-on, the first upper switch S1 and the first lower switch S2 enter a normal operation period T1 to T2 to flow current Isa in the first upper switch S1 according to applied voltage as shown in FIG. 5, such that the current Isa flowing in the first upper switch S1 is slowly reduced over time. In this case, voltage Vsa of the first upper switch S1 becomes 0 by being turned-on.

Further, when a predetermined time lapses after the first upper switch S1 and the first lower switch S2 are turned-on, the first upper switch S1 and the first lower switch S2 enter the normal operation period to flow current Isb in the first lower switch S2 according to applied DC voltage as shown in FIG. 5, such that the current Isb flowing in the first lower switch S2 is slowly reduced over time. In this case, voltage Vsb of the first lower switch S2 becomes 0 by being turned-on.

Further, the current flowing in the first upper switch S1 and the first lower switch S2 is the same in the normal operation period T1 to T2.

Next, after (period T2 to T3 of FIG. 5), the first upper switch S1 is turned-off and the first lower switch S2 maintains a turn-on state. Next, as shown in FIG. 4B, the current loop configured of the A phase winding, the first lower switch S2, the second lower switch S4, and the second diode D2 are formed (the A phase operation mode 2).

In this case, as the first upper switch S1 is turned-on, current does not flow in the first upper switch S1 and the Vsa across the first upper switch approximates the applied DC voltage.

In addition, the first lower switch S2 maintains the turn-on state, such that current is slowly reduced and the voltage thereof is not also fluctuated as 0 voltage due to the turn-on state.

In this case, however, when the first upper switch S1 is turned-off and voltage is applied across the first upper switch, current flowing in the A phase winding is circulated through an internal diode of the second lower switch S4 and the second diode D2.

Therefore, current Isd circulated to the A phase winding flows in the internal diode of the second lower switch S4 in the state in which the voltage across the first lower switch S2 maintains 0 voltage as shown in FIG. 5.

Next, as shown in FIG. 4B, the current flowing in the current loop configured of the A phase winding, the first lower switch S2, the second lower switch S4, and the second diode D2 is slowly reduced.

In this case, current Idb flowing in the second diode D2 is the same as the current flowing in the first lower switch S2 as shown in FIG. 5.

Next, in this state, the first lower switch S2 continues to maintain the turn-on state and the second lower switch S4 is turned-on (the time period T3 to T4 of FIG. 5).

In addition, the first lower switch S2 maintains the turn-on state, such that current is slowly reduced and the voltage thereof is not also fluctuated as 0 voltage due to the turn-on state.

In this case, as the second lower switch S4 is turned-on, as shown in FIG. 4C, the current flowing in the A phase winding directly flows through the second lower switch S4 rather than through the internal diode of the second lower switch S4 and like the previous state, the current flowing in the A phase winding through the second diode D2 is still circulated (maintain the A phase operation mode 2 state).

Therefore, the current circulated to the A phase winding flows in the second lower switch S4 in the state in which the voltage Vsd across the second lower switch S4 maintains 0 voltage as shown in FIG. 5.

In this case, the current flowing in the current loop configured of the A phase winding, the first lower switch S2, the second lower switch S4, and the second diode D2 is slowly reduced.

Further, the second lower switch S4 may minimize the switching loss by turning-on the switch in the state of the zero-voltage or less.

Further, when the second lower switch S4 is turned-on in the state of the zero-voltage or less, a current slope is gradually reduced by a speed electromotive force depending on the following Equation 1.

$${V}_{dc} = {L}_{motor} \cdot \frac{d i}{d t} + i \cdot \frac{d {L}_{motor}}{d θ} \cdot ω \qquad [ Equation 1 ]$$

Next, the first lower switch S2 is turned-off (see the time period T4 to T5 of FIG. 5) in the state in which the second lower switch S4 is maintained.

Further, as the first lower switch S2 is turned-off, as shown in FIG. 4D, the current loop configured of the internal diode of the first upper switch S3, the first diode D1, the A phase winding, the second diode, and the second lower switch is formed.

In addition, as the first lower switch S2 is turned-off, as shown in FIG. 5, current does not flow in the first lower switch S2 and voltage approximates input voltage by being turned-off.

In this case, the circulating current of the A phase winding still flows in the second lower switch S4 and circulating current Isc of the A phase winding flows in the internal diode of the second upper switch S3 as shown in FIG. 5.

Further, the voltage Vsc across the second upper switch is changed to a 0 voltage state according to the flow of circulating current through the internal diode.

In this case, current Ida flowing through the first diode D1 is the same as the current flowing through the second diode D2 as shown in FIG. 5.

After (see the time period T5 to T6 of FIG. 5) the second upper switch S3 is turned-on in the state in which the second lower switch S4 is turned-on.

Further, the current loop configured of the second upper switch S3, the B phase winding, and the second lower switch S4 and the current loop configured of the first upper switch S3, the first diode D1, the A phase winding, the second diode, and the second lower switch overlap each other as shown in FIG. 4E.

Further, current flows in the second upper switch S3 and the second lower switch S4 by a difference between the current flowing in the B phase winding and the current flowing in the A phase winding (the overlapping of the A phase operation mode 3 and the B phase operation mode 1).

In this case, the voltage across the second upper switch S3 is changed to a 0 voltage state according to the flow of circulating current through the internal diode, such that the first upper switch is turned-on in the zero-voltage state, thereby minimizing the switching loss.

After (the time period T6 to T7 of FIG. 5), when the second upper switch S3 and the second lower switch S4 continue to maintain the turn-on state, the current flowing in the A phase winding is slowly reduced and therefore, only the current loop flowing in the second upper switch S3 and the second lower switch S4 remains (the B phase operation mode 1).

Next, the second upper switch S3 is turned-off (the B phase operation mode 2) in the state in which the second lower switch S4 maintains the turn-on state. Alternatively, the first lower switch S2 is turned-on (the B phase operation mode 3) in the state in which the second lower switch S4 is turned-on after a predetermined time lapses and the first upper switch S1 is turned-on in the state in which the second lower switch S4 maintains a turn-on state to repeat a process (the A phase operation mode 1) of maintaining (the overlapping of the B phase operation mode 3 and the A phase operation mode 1), thereby driving the motor.

According to the preferred embodiment of the present invention as described above, the zero-voltage switching can be implemented to reduce the switching loss in the motor requiring the high speed rotation.

In addition, according to the preferred embodiments of the present invention, the costs and size can be saved by reducing the number of diodes, as compared with the switching apparatus for the SRM according to the prior art.

Further, according to the preferred embodiment of the present invention, the torque ripple can be reduced as compared with the switching apparatus for the SRM according to the prior art.

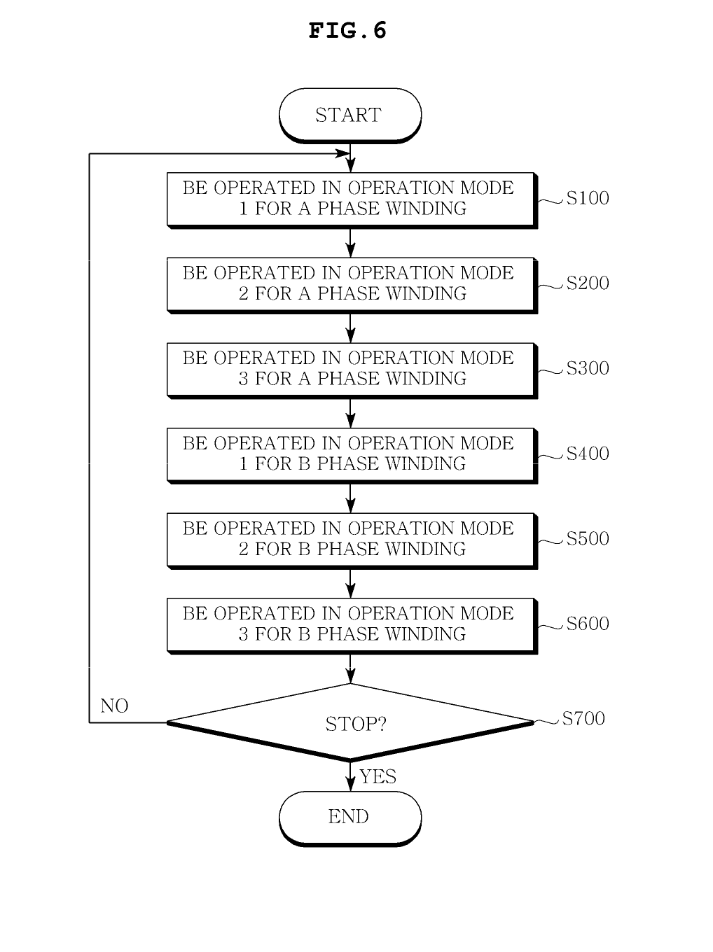

FIG. 6 is a flow chart of a switching control method for a switched reluctance motor according to the first preferred embodiment of the present invention.

Referring to FIG. 6, the microprocessor controls the zero-voltage switch converter to operate the A phase winding of the two phase SRM in the operation mode 1 (S100).

Describing this in more detail, the first upper switch S1 and the first lower switch S2 are turned-on to form the current loop configured of the first upper switch S1, the A phase winding, and the first lower switch S2 as shown in FIG. 4A.

Next, the microprocessor controls the zero-voltage switching converter to operate in the operation mode 2 for the A phase winding, thereby driving the motor (S200).

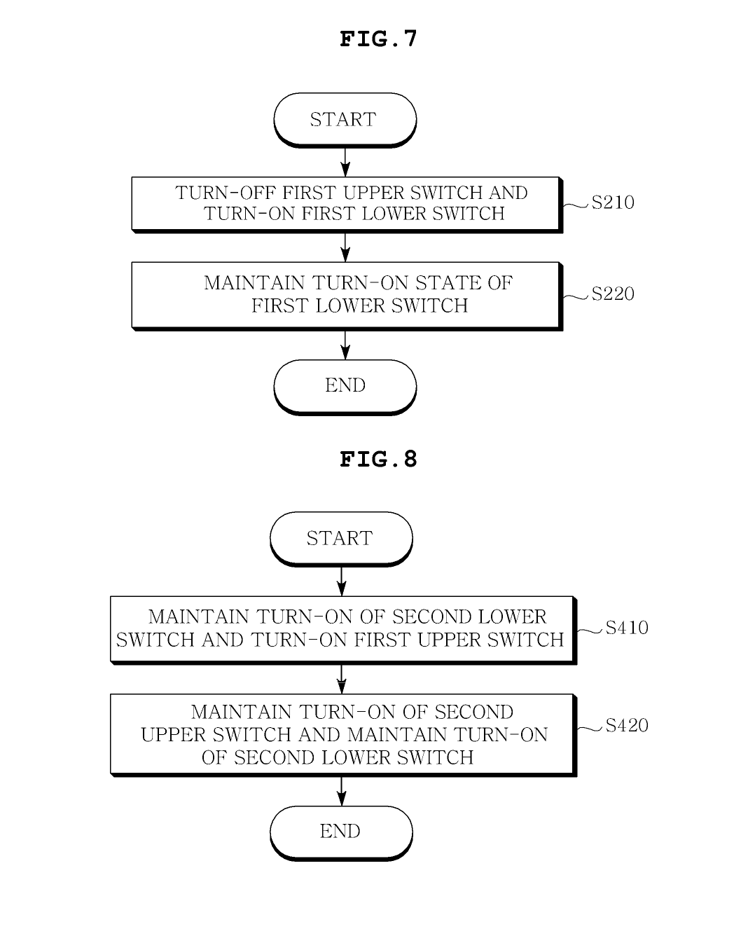

Describing this in more detail, as shown in FIG. 7, the first upper switch S1 is turned-off and the first lower switch 2 maintains a turn-on state (S210). In this case, the current loop configured of the A phase winding, the first lower switch S2, the second lower switch S4, and the second diode D2 is formed.

As such, when the first upper switch S1 is turned-off and voltage is applied across the first upper switch, the current flowing in the A phase winding is circulated through an internal diode of the second lower switch S4 and the second diode D2.

Therefore, the current circulated to the A phase winding flows in the internal diode of the second lower switch S4 in the state in which the voltage across the first lower switch S2 maintains 0 voltage.

Next, in this state, the first lower switch S2 continues to maintain the turn-on state and the second lower switch S4 is turned-on (S220).

In addition, the first lower switch S2 maintains the turn-on state, such that current is slowly reduced and the voltage thereof is not also fluctuated as 0 voltage due to the turn-on state.

In this case, as the second lower switch S4 is turned-on, the current flowing in the A phase winding directly flows through the second lower switch S4 rather than through the internal diode of the second lower switch S4 and like the previous state, the current flowing in the A phase winding through the second diode D2 is still circulated.

Therefore, the current circulated to the A phase winding flows in the second lower switch S4 in the state in which the voltage across the first lower switch S2 maintains 0 voltage.

Further, the current flowing in the current loop configured of the A phase winding, the first lower switch S2, the second lower switch S4, and the second diode D2 is slowly reduced.

In this case, the second lower switch S4 implement the zero-voltage switch turn-on, such that the current slope is gradually reduced by the speed electromotive force.

Next, the microprocessor controls the zero-voltage switching converter so as to be operated in the operation mode 3 for the A phase winding (S300).

Describing this in more detail, the first lower switch S2 is turned-off in the state in which the second lower switch S4 is maintained.

Further, as the first lower switch S2 is turned-off, the current loop configured of the internal diode of the second upper switch S3, the first diode D1, the A phase winding, the second diode D2, and the second lower switch S4 is formed.

In addition, as the first lower switch S2 is turned-off, current does not flow in the first lower switch S2 and voltage approximates input voltage by being turned-off.

In this case, the circulating current of the A phase winding still flows in the second lower switch S4 and the circulating current of the A phase winding flows in the internal diode of the first upper switch S1.

Further, the voltage across the first upper switch is changed to a 0 voltage state according to the flow of circulating current through the internal diode.

Continuously, the microprocessor operates the B phase winding in the operation mode 1 in the state in which the microprocessor controls the zero-voltage switching converter so as to be operated in the operation mode 3 for the A phase winding.

Describing this in more detail, as shown in FIG. 8, the second upper switch S3 is turned-on in the state in which the second lower switch S4 maintains the turn-on state (S410).

In addition, the current flows in the second upper switch S3 and the second lower switch S4 by the difference between the current flowing in the B phase winding and the current flowing the A phase winding. Further, when the current flowing in the A phase winding is slowly reduced and thus, the current flowing the second upper switch S3 and the second lower switch S4 approximates the current flowing the B phase winding.

In this case, the voltage across the first upper switch is changed to the 0 voltage state according to the flow of circulating current through the internal diode and therefore, the first upper switch implements the zero-voltage switch turn-on (the overlapping of the operation mode 3 for the A phase winding and the operation mode 1 for the B phase winding).

Thereafter, when the second upper switch and the second lower switch continue to maintain the turn-on state (S420), the A phase current is reduced to 0 and thus, does not flow and the overall input voltage is transferred to the B phase to slowly increase the current flowing in the B phase and when the current reaches a predetermined value, the speed electromotive force is larger than the input voltage and thus, the current is slowly reduced (the B phase operation mode 1).

Continuously, the microprocessor controls the zero-voltage switching converter to turn-on the first lower switch S2 in the state in which the second lower switch S4 is turned-on so as to be driven in the operation mode 2 (S500). Continuously, the first upper switch S1 is turned-on in the state in which the second lower switch S4 maintains the turn-on state so as to be driven in the operation mode 3 (S600).

In addition, the microprocessor determines whether the motor stops (S700) to perform S100 if it is determined that the motor does not stop. In this case, the operation mode 1 for the A phase winding is performed in the state in which the operation mode 3 for the B phase winding is maintained.

According to the preferred embodiments of the present invention, it is possible to reduce the switching loss in the motor requiring the high speed rotation by implementing the zero-voltage turn-on.

In addition, according to the preferred embodiments of the present invention, it is possible to save costs by reducing the number of diodes, as compared with the switching apparatus for the SRM according to the prior art.

In addition, according to the preferred embodiments of the present invention, it is possible to reduce the size by reducing the number of diodes, as compared with the switching apparatus for the SRM according to the prior art.

Moreover, according to the preferred embodiment of the present invention, it is possible to reduce the size of the EMI filter configuring the inductor and the capacitor by reducing the ripple of the input current, as compared with the switching driving apparatus of the SRM according to the prior art.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. A switching apparatus for a two-phase SRM, comprising:
a rectifier rectifying commercial power; and
a zero-voltage switching converter including a pair of upper and lower switches that is vertically connected to each of two phase windings in series and a pair of diodes that is cross-connected across the two phase windings to be operated in operation modes 1 to 3 for each phase winding and provide commercial power supplied from the rectifier to the two-phase SRM so as to operate the two-phase SRM.

2. The switching apparatus as set forth in claim 1, further comprising:
a microprocessor sensing a position and a speed of the two-phase SRM to control the zero-voltage switching converter so as to operate the two-phase SRM.

3. The switching apparatus as set forth in claim 1, wherein the pair of upper and lower switches includes:
a first upper switch connected to an upper portion of any one of the two phase windings in series;
a first lower switch connected to a lower portion of any one of the two phase windings in series;
a second upper switch connected to an upper portion of the other of the two phase windings in series; and
a second lower switch connected to a lower portion of the other of the two phase windings in series, and
the pair of diodes includes:
a first diode having an anode connected to a contact between any one of the two phase windings and the first lower switch and a cathode connected to a contact between the other of the two phase windings and the second upper switch; and
a second diode having an anode connected to a contact between the other of the two phase windings and a cathode connected to a contact between the other of the two phase windings and the upper switch.

4. The switching apparatus as set forth in claim 3, wherein the zero-voltage switching converter controls the first lower switch and the second upper switch based on an encoder waveform to control an advance angle.

5. The switching apparatus as set forth in claim 3, wherein the zero-voltage switching converter controls the first upper switch and a second lower switch to control a conducting angle.

6. The switching apparatus as set forth in claim 3, wherein the first upper switch and the first lower switch are turned-on so as to be operated in the operation mode 1 for any one of the two phase windings of the two-phase SRM; and
the second upper switch and the second lower switch are turned-on so as to be operated in the operation mode 1 for the other of the two phase windings of the two-phase SRM.

7. The switching apparatus as set forth in claim 3, wherein the first upper switch is turned-off and the first lower switch is turned-on and then, the second lower switch is turned-on so as to be operated in the operation mode 2 for any one of the two phase windings of the two-phase SRM; and
the second upper switch is turned-off and the second lower switch is turned-on and then, the first lower switch is turned-on so as to be operated in the operation mode 2 for any one of the two phase windings of the two-phase SRM.

8. The switching apparatus as set forth in claim 3, wherein an internal diode of the second upper switch provides a circulating path of current in the state in which the second lower switch is turned-on so as to be operated in the operation mode 3 for any one of the two phase windings of the two-phase SRM, and
an internal diode of the first upper switch provides a circulating path of current in the state in which the first lower switch is turned-on so as to be operated in the operation mode 3 for any one of the two phase windings of the two-phase SRM.

9. The switching apparatus as set forth in claim 1, wherein the microprocessor controls the zero-voltage switching converter so as to be sequentially changed from the operation mode 1 to the operation mode 2 and the operation mode 3 for any one of the two phase windings and sequentially changed from the operation mode 1 to the operation mode 2 and the operation mode 3 for the other of the two phase windings.

10. The switching apparatus as set forth in claim 9, wherein when the microprocessor controls the zero-voltage switching converter so as to be changed from the operation mode 3 for any one of the two phase windings to the operation mode 1 for the other of the two phase windings, the operation mode 3 for any one of the two phase windings and the operation mode 1 for the other of the two phase windings overlap each other for a predetermined time.

11. A switching control method for a two-phase SRM, comprising:
(A) controlling, by a microprocessor, a zero-voltage switching converter including a pair of upper and lower switches that is vertically connected to each of two phase windings in series and a pair of diodes that is cross-connected across the two phase windings to be operated in operation modes 1 to 3 for each of the two phase windings to excite any one of the two phase windings and then, removing residual current; and
(B) controlling, by the microprocessor, the zero-voltage switching converter to excite the other of the two phase windings and then, removing residual current.

12. The switching control method as set forth in claim 11, wherein the pair of upper and lower switches includes:
a first upper switch connected to an upper portion of any one of the two phase windings in series;
a first lower switch connected to a lower portion of any one of the two phase windings in series;
a second upper switch connected to an upper portion of the other of the two phase windings in series; and
a second lower switch connected to a lower portion of the other of the two phase windings in series, and
the pair of diodes includes:
a first diode having an anode connected to a contact between any one of the two phase windings and the first lower switch and a cathode connected to a contact between the other of the two phase windings and the second upper switch; and
a second diode having an anode connected to a contact between the other of the two phase windings and a cathode connected to a contact between the other of the two phase windings and the upper switch.

13. The switching control method as set forth in claim 12, wherein in the step (A), the zero-voltage switching converter is controlled so as to be sequentially changed from the operation mode 1 to the operation mode 2 and the operation mode 3 for any one of the two phase windings, and
in the step (B), the zero-voltage switching converter is controlled so as to be sequentially changed from the operation mode 1 to the operation mode 2 and the operation mode 3 for the other of the two phase windings.

14. The switching control method as set forth in claim 13, wherein when the microprocessor controls the zero-voltage switching converter so as to be changed from the operation mode 3 for any one of the two phase windings to the operation mode 1 for the other of the two phase windings, the operation mode 3 for any one of the two phase windings and the operation mode 1 for the other of the two phase windings overlap each other for a predetermined time.

15. The switching control method as set forth in claim 13, wherein in the step (A), the first upper switch and the first lower switch are turned-on so as to be operated in the operation mode 1 for any one of the two phase windings of the two-phase SRM; and
in the step (B), the second upper switch and the second lower switch are turned-on so as to be operated in the operation mode 1 for the other of the two phase windings of the two-phase SRM.

16. The switching control method as set forth in claim 13, wherein in the step (A), the first upper switch is turned-off and the first lower switch is turned-on and then, the second lower switch is turned-on so as to be operated in the operation mode 2 for any one of the two phase windings of the two-phase SRM; and
in the step (B), the second upper switch is turned-off and the second lower switch is turned-on and then, the first lower switch is turned-on so as to be operated in the operation mode 2 for any one of the two phase windings of the two-phase SRM.

17. The switching control method as set forth in claim 13, wherein in the step (A), an internal diode of the second upper switch provides a circulating path of current in the state in which the second lower switch is turned-on so as to be operated in the operation mode 3 for any one of the two phase windings of the two-phase SRM, and
in the step (B), an internal diode of the first upper switch provides a circulating path of current in the state in which the first lower switch is turned-on so as to be operated in the operation mode 3 for any one of the two phase windings of the two-phase SRM.
